(19) United States
(12) Patent Application Publication
(10) Pub. No.: US 2008/0038690 A1
(43) Pub. Date: Feb. 14, 2008

(54) Dental finishing, sanding and/or polishing floss

(76) Inventor: Jeffrey T. Allen, Bloomington, IN (US)

Correspondence Address: BOWMAN & ASSOCIATES, 1016 3rd Avenue, SW, Suite #106, CARMEL, IN, 46032, US

(21) Appl. No.: 11/891,820

(22) Filed: Aug. 13, 2007

Related U.S. Application Data
(60) Provisional application No. 60/837,482, filed on Aug. 14, 2006.

(51) Int. Cl. A61C 17/00; A61C 15/04

(52) U.S. Cl. 433/142; 427/2.29

(57) ABSTRACT

An abrading dental floss is characterized by dental floss having a dental abrasive on at least a portion thereof suitable for polishing, sanding and/or finishing dental restorative material such as dental resin. The dental abrading material is impregnated into or provided onto the dental floss. In one form, the dental abrading floss has an abrading/abrasion/polishing/finishing/sanding section situated between lengths of the dental floss. The abrading polishing section may be formed of an alternating pattern of non-abrasive portions and abrasive portions along a length of the floss. The abrasive portions may be of a single grit or texture of the dental abrasive or may be of different grits of the dental abrasive. In another form, the dental abrading floss has a single grit of a dental abrasive along its entire length. In yet another form, the dental abrading floss comprises a plastic sheet of having a dental abrasive thereon or therein situated between lengths of the dental floss. The dental abrasive may be of a single grit or different grits of the dental abrasive. For different grits of the dental abrasive, it is preferred, but not necessary, that they gradually change in grit size.

### CROSS-REFERENCE TO RELATED APPLICATIONS

This patent application claims the benefit of and/or priority to U.S. provisional patent application Ser. No. 60/837,482 filed Aug. 14, 2006, entitled “Dental Finishing and Polishing Floss”, the entire contents of which is specifically incorporated herein by reference.

### BACKGROUND OF THE INVENTION

1. Field of the Invention

The present invention relates to dental floss/tape used for interproximal finishing, polishing and/or sanding of a dental restorative material.

2. Background Information

Resins rather than amalgams are now predominately used for filling cavities and/or as a general dental restorative material. These resins possess properties that closely match natural teeth with respect to structural properties such as cohesive strength, coefficient of thermal expansion and wearability. Also, aesthetic considerations such as color stability, refractive index, plaque repellency, polishability and opacity are important factors make resins a good choice as a dental restorative material.

These resins have good forming characteristics so that they can be shaped to fit a cavity area or molded into place in order to repair chipped or damaged teeth. However, it is necessary to shape the repaired area by polishing or sanding the resin once the resin is cured. This is currently done by using a plastic strip that usually has a polishing material thereon. These plastic strips however, are not ideal.

It is therefore the object of the present invention to overcome the deficiencies in prior art dental restorative material polishing/sanding/finishing devices.

### SUMMARY OF THE INVENTION

The present invention is an abrasive or abrading dental floss for polishing, sanding and/or finishing (abrading) dental restorative material. The present abrasive dental floss is characterized by dental floss having a dental abrasive on at least a portion thereof suitable for polishing, sanding and/or finishing dental restorative material such as dental resin. The dental abrasive (polishing, sanding and/or finishing) material is impregnated into or provided onto the dental floss. The dental abrasive may be provided on a strip of dental plastic situated between the dental floss.

In one form, the present dental floss has an abrading/polishing/finishing section situated between lengths of the dental floss. The abrading polishing section may be formed of an alternating pattern of non-abrasive portions and abrasive portions along a length of the floss. The abrasive portions may be of a single grit of the dental abrasive or may be of different grits of the dental abrasive. For different grits of the dental abrasive, it is preferred, but not necessary, that they gradually change in grit size.

In another form, the present dental floss has a single grit of a dental abrasive along its entire length.

In yet another form, the present dental floss comprises a plastic sheet of having a dental abrasive thereon or therein situated between lengths of the dental floss. The dental abrasive may be of a single grit of the dental abrasive or may be of different grits of the dental abrasive. For different grits of the dental abrasive, it is preferred, but not necessary, that they gradually change in grit size.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 depicts an embodiment of a piece or strip of dental finishing, polishing and/or sanding floss fashioned in accordance with the present principles;

FIG. 2 depicts another embodiment of a piece or strip of dental finishing, polishing and/or sanding floss fashioned in accordance with the present principles; and

FIG. 3 depicts a further embodiment of a piece or strip of dental finishing, polishing and/or sanding floss in fashioned accordance with the present principles.

Like reference numerals indicate the same or similar parts throughout the several figures.

A detailed description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE PREFERRED EMBODIMENTS

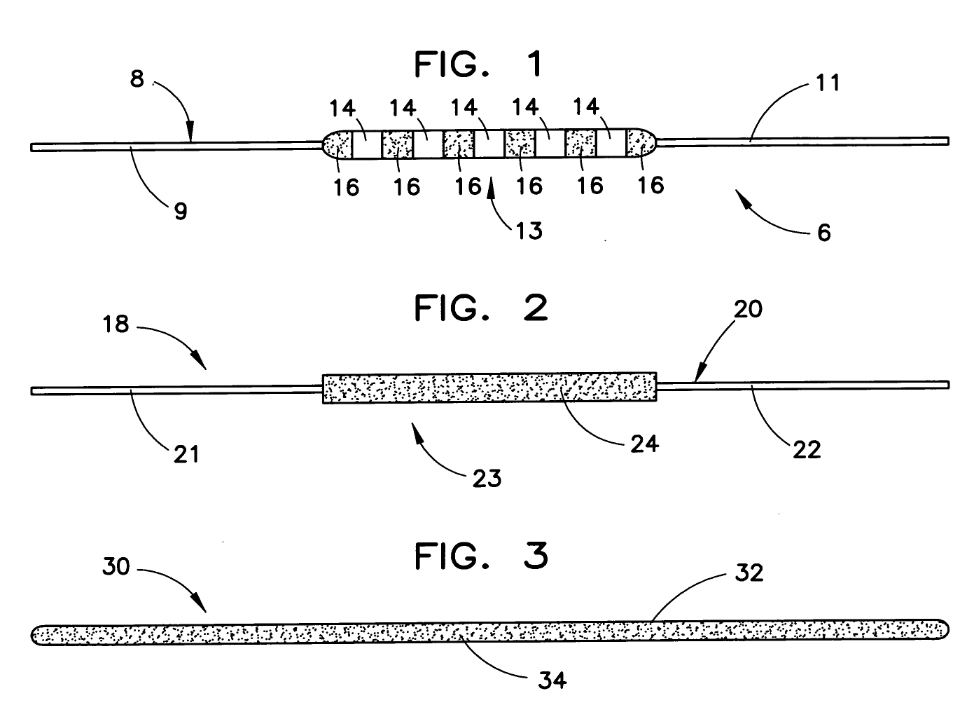

Referring to FIG. 1 there is depicted an exemplary embodiment of the present invention. Particularly, there is depicted a strip or piece of dental finishing, polishing and/or sanding floss (collectively, dental abrasion or abrading floss), generally designated 6, fashioned in accordance with the present principles. The dental abrasion floss 6 is defined by a length of dental floss 8 that is made from a typical dental floss material such as Goretex® or the like. As such, the length of dental floss 8 may be a continuous piece/strip or an individual piece/strip of any length.

In accordance with the principles of the present invention, the length of dental floss 8 has a finishing/polishing/sanding (abrasion or abrading) section 13 situated between lengths 9 and 11 of the dental floss 8. The abrasion or abrading section 13 is formed of an alternating pattern of non-abrasive/abrading portions 14 and abrasive/abrading portions 16 along the length of the abrasion or abrading section 13. The abrasion/abrading section 13 is impregnated into or coated onto the dental floss 8. The abrasive/abrading portions 16 are formed of a gritty material such as is known in the art for finishing, polishing and/or sanding (abrading) a dental restorative material (e.g. a dental resin).

The abrasive/abrading portions 16, in one form, are each of the same grit or texture. Different dental abrasion/abrading flosses 6 (or abrasive/abrading sections 13 thereof) may have grit portions 16 of different grits or textures. For instance, one dental abrasion/abrading floss 6 may have “coarse” grit abrasive/abrading portions 16 for coarse finishing/polishing/sanding, one dental abrasion/abrading floss 6 may have “medium” grit abrasive/abrading portions 16 for medium finishing/polishing/sanding, and one dental abrasion/abrading floss 6 may have “fine” grit abrasive/abrading portions 16 for fine finishing/polishing/sanding.

Alternatively, in another form of the present invention, the abrasive/abrading portions 16 are of different grits or textures along the length of the abrading/abrasion portion 13. Preferably, however, the same dental abrading/abrasion floss 6 does not have a wide variant of grits or textures along its length (e.g. “fine” to “coarse” abrasive portions 16), but may if desired. Typically, however, the abrading/abrasion portion 13 has a range of abrasive portions 16 within a same or similar grit or texture range such as a range of “fine” grits, a range of “medium” grits, or a range of “coarse” grits. For instance, a first abrasive portion 16 (as arbitrarily viewed starting from the left side of FIG. 1) may have a “super, super fine” grit, then a “super fine” grit, and so forth within a range of “fine” grits.

It another form of the present dental abrading/abrasion floss 6, the abrading/abrasion section 13 has been enlarged for detail in illustrating the alternating pattern of non-abrasive/abrading portions 14 and abrasive/abrading portions 16 along the length thereof. The abrading/abrasion section 13 is thus the same size as the dental floss 8.

Referring now to FIG. 2 there is depicted another embodiment of the present dental abrasion floss fashioned in accordance with the principles of the present invention. Particularly, there is depicted a piece of dental polishing and/or sanding floss, generally designated 18, fashioned in accordance with the present principles. The dental abrasion floss 18 is defined by a length of floss 20 that is made from a typical floss material such as Goretex® or the like. As such, the length of floss 20 may be a continuous piece/strip or an individual strip of piece/any length.

In accordance with the principles of the present invention, the length of floss 20 has a finishing/polishing/sanding (abrading or abrasion) section 23 connected between portions 21 and 22 of the length of floss 20. The abrading/abrasion section 23 is formed of a flat plastic strip having a dental finishing/polishing/sanding (abrasion or abrading) material 24 impregnated into or coated onto the abrading/abrading section 23. The dental abrading material 24 is a gritty or textured material such as is known in the art for finishing, polishing and/or sanding (abrading) a dental restorative material (e.g. a dental resin). The dental polishing/sanding material 24 is of a single grit or texture such as “fine”, “medium”, “coarse” or the like.

Referring to FIG. 3 there is depicted another embodiment of the present dental abrasion floss fashioned in accordance with the principles of the present invention. Particularly, there is depicted a piece of dental finishing, polishing and/or sanding (abrasion or abrading) floss, generally designated 30. The finishing/polishing/sanding floss 30 is defined by a length of dental floss 32 that is made from a typical floss material such as Goretex® or the like. As such, the length of floss 32 may be a continuous piece/strip or an individual piece/strip of any length.

The length of floss 32 is entirely impregnated or coated with a dental abrasion or abrading material 34. The abrasion or abrading material 34 is a gritty or textured material such as is known in the art for finishing, polishing and/or sanding (abrading) a dental restorative material (e.g. a dental resin). The dental abrasion or abrading material 34 is of a single “grit” such as “fine”, “medium”, “coarse” or the like.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected.

What is claimed is:

1. An element for abrading dental restorative material, the element comprising:
a length of dental floss formed of a dental floss material; and
an abrasion section formed within the length of the dental floss;
the abrasion section incorporating an abrasion material for abrading dental restorative material.

2. The element of claim 1, wherein the abrasion section is formed between lengths of the dental floss.

3. The element of claim 1, wherein the abrasion material has a grit size comprising one of a fine texture, a medium texture and a coarse texture.

4. The element of claim 1, wherein the abrasion material has a grit size that increases along a length of the abrasion section.

5. The element of claim 1, wherein the abrasion section has alternating portions of the abrasion material and no abrasion material.

6. The element of claim 5, wherein sequential ones of the portions of the abrasion material has a grit size that increase along a length of the abrasion section.

7. An element for abrading dental restorative material, the element comprising:
a length of dental floss formed of a dental floss material; and
an abrasion section formed along the entire length of the dental floss;
the abrasion section incorporating a dental restorative material abrading material.

8. The element of claim 7, wherein the abrasion material has a grit size comprising one of a fine texture, a medium texture and a coarse texture.

9. The element of claim 7, wherein the abrasion material has a grit size that increases along a length of the abrasion section.

10. The element of claim 7, wherein the abrasion section has alternating portions of the abrasion material and no abrasion material.

11. The element of claim 10, wherein sequential ones of the portions of the abrasion material has a grit size that increase along a length of the abrasion section.

12. An element for abrading dental restorative material, the element comprising:
a length of dental floss formed of a dental floss material; and
an abrasion section formed between first and second portions of dental floss of the length of the dental floss;
the abrasion section incorporating a dental restorative material abrading material.

13. The element of claim 12, wherein the abrasion material has a grit size comprising one of a fine texture, a medium texture and a coarse texture.

14. The element of claim 12, wherein the abrasion material has a grit size that increases along a length of the abrasion section.

15. The element of claim 12, wherein the abrasion section has alternating portions of the abrasion material and no abrasion material.

16. The element of claim 15, wherein sequential ones of the portions of the abrasion material has a grit size that increase along a length of the abrasion section.

17. The element of claim 12, wherein the abrasion section is formed of a plastic strip.

18. The element of claim 17, wherein the plastic strip has alternating portions of the abrasion material and no abrasion material.

19. The element of claim 17, wherein the abrasion material has a grit size that increases along a length of the plastic strip.

20. The element of claim 17, wherein the abrasion material has a grit size comprising one of a fine texture, a medium texture and a coarse texture.
